(19) United States
(12) Patent Application Publication
(10) Pub. No.: US 2004/0169771 A1
(43) Pub. Date: Sep. 2, 2004

(54) Thermally cooled imaging apparatus

(76) Inventors: Richard G. Washington, Marble Falls, TX (US); Thao D. Hovanky, Austin, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/732,192

(22) Filed: Dec. 10, 2003

Related U.S. Application Data
(60) Provisional application No. 60/437,709, filed on Jan. 2, 2003.

(51) Int. Cl. H04N 5/225

(52) U.S. Cl. 348/374; 250/239; 257/433

(57) ABSTRACT

Systems and methods for housing and/or cooling image sensors, for example, for use in video camera assemblies or any other application employing image sensors. The image sensors may be cooled within a sealed environment (e.g., vacuum sealed or dry gas sealed environment) to minimize the amount of power required by reducing heat transfer due to convection, and to substantially eliminate problems of fogging or condensation of the image sensor. In one embodiment, the systems and methods may be employed for cooling CMOS image sensors to improve low light performance of the CMOS sensors.

This patent application claims priority to copending U.S. Provisional Patent Application Serial No. 60/437,709, filed Jan. 2, 2003, and entitled “THERMOELECTRIC COOLED IMAGING APPARATUS” by Washington et al., the entire disclosure of which is incorporated herein by reference.

### BACKGROUND OF THE INVENTION

The present invention relates generally to imaging assemblies, and more particularly to imaging assemblies for video cameras.

Existing video surveillance cameras employ charge coupled device (“CCD”) image sensors as an integral part of the video camera assembly. CCD image sensors provide good performance over the typical temperature range but suffer from several drawbacks. For example, CCD sensors require multiple voltages and a complex interface. This complexity results in increased parts and manufacturing costs. Furthermore, typical CCD technology (e.g., silicon process, geometries, etc.) tends to limit the rate at which the data can be read out of the CCD image sensor. In this regard, data rates associated with normal National TV Standards Committee (“NTSC”) and/or Phase Alternating Line (“PAL”) resolution and frame rates may be achieved by existing CCD imaging technology. However, data rates associated with higher resolution imaging (e.g., 1280×1024 or higher) push or exceed the limits of existing CCD technology when the frame rates are maintained at levels acceptable to most current applications (e.g. 15 to 30 frames per second or greater).

### SUMMARY OF THE INVENTION

Disclosed herein are systems and methods for housing and/or cooling image sensors (e.g., complementary MOS “CMOS” or CCD image sensors), for example, for use in video camera assemblies (e.g., closed circuit video cameras) or any other application employing image sensors. The disclosed systems and methods may be configured to employ integrated sealed enclosures (e.g., vacuum or gas-filled sealed enclosures) to provide a relatively low power solution to cooling CMOS or CCD image sensors. Advantageously, in one embodiment the disclosed systems and methods may be implemented to expand the types of applications for which CMOS image sensors may be employed, e.g., to include applications where CCD image sensors were typically employed in the past. This is significant since CCD technology is not advancing on the same technology curve as is CMOS technology, meaning that CCD technological advancement and cost reduction rates are currently limited as compared to advances and cost reductions currently being achieved with CMOS technology.

The disclosed systems and methods may be employed for cooling image sensors, for example, for cooling CMOS image sensors to improve low light performance of the CMOS sensors. In this regard, typical CMOS structures tend to inherently have a lower Signal to Noise Ratio (“SNR”) than typical CCD image sensors employed in existing video camera applications, and this reduced SNR of CMOS sensors is most visibly noticeable when at relatively lower light levels and relatively higher image sensor temperatures. Advantageously, the disclosed systems and methods for cooling CMOS image sensors may be implemented to increase the SNR of CMOS image sensors without, for example, requiring longer exposure times that also reduce the frame rate.

Advantages of the disclosed systems and methods may be illustrated by considering temperature effects on performance of a CMOS image sensor, e.g., temperature effects on CMOS image sensor may be partially determined by the increase in photodiode dark current that occur as the temperature increases (photodiode dark current is a major factor in setting the absolute noise floor since this is a measure of current flow in a totally dark environment). In one example, a commercial higher resolution CMOS image sensor has a photodiode dark current of about 6,250 e-/pixel/sec (electrons per pixel per sec) at room temperature (25° C.) and about 25,000 e-/pixel/sec at 40° C., thus exhibiting a 4× increase in current over a 15° C. range. Therefore, using the disclosed systems and methods to achieve even moderate cooling of a CMOS sensor may have a dramatic effect on the visual quality of the image sensor output.

The disclosed systems and methods may be implemented in one embodiment to provide cooling of CMOS and other type sensors and to provide a significant image quality boost, while at the same time minimizing the cost of additional power associated with such cooling. For example, the disclosed systems and methods may advantageously employ a thermally isolated thermal electric cooler (“TEC”) to provide efficient CMOS image sensor cooling without experiencing unacceptable power usage. Further advantageously, the CMOS image sensor may be cooled within a sealed environment (e.g., vacuum sealed environment or sealed gaseous atmosphere such as dry gas sealed environment) to minimize the amount of power required by reducing heat transfer due to convection, and to substantially eliminate problems of fogging or condensation of the image sensor (e.g., as may occur when the temperature of the cooled image sensor drops below the dew point of the surrounding atmosphere).

The disclosed systems and methods may also be implemented in ways that advantageously employ efficient use of heat transfer from an image sensor to an environment external to an image sensor enclosure apparatus, so that an image sensor is adequately cooled even when the image sensor is contained within an unsealed (e.g., non-vacuum, non-sealed gaseous atmosphere) image sensor chamber of the enclosure apparatus. For example, in one embodiment an image sensor enclosure apparatus may be intentionally configured with an unsealed image sensor chamber such that sufficient cooling of the image sensor is achieved while at the same time avoiding fogging or condensation of optical components of the apparatus. In another embodiment an image sensor enclosure apparatus may be initially configured with a sealed image sensor chamber (e.g., image sensor vacuum chamber or dry gas-containing image sensor chamber), but in a manner such that sufficient cooling of the image sensor without occurrence of fogging or condensation phenomenon may be achieved even in the event the seal is broken or degrades over time, e.g., allowing contact with the atmosphere of the environment external to the chamber.

In one exemplary embodiment, the disclosed systems and methods may be implemented with a sealed enclosure apparatus that may advantageously include two components: a sealed image sensor chamber housing enclosure component formed from a heatsink structure (e.g., a TEC requires sufficient heat sinking in order to maintain an acceptable level of performance), and an optical quality housing (e.g., polycarbonate) chamber lid enclosure component that includes a molded chamber window. Such a two piece enclosure has several design features that may advantageously facilitate ease of manufacturing, e.g., by reducing or substantially eliminating problems associated with manufacturing a vacuum packed or sealed product from the standpoint of maintaining the desired vacuum level over minimum air transfer over an extended period of time and temperature cycles, and problems associated with creating long term air tight seals across multiple interfaces (windows, main chamber, heatsinks, etc.). From an electronic imaging standpoint the electronics utilized for this exemplary embodiment may include a higher resolution sensor that may be actively cooled using, for example, a single or multi-stage TEC. Although a multiple stage TEC may be employed for increased thermal gradient, a single stage TEC may be employed where it is suitable to achieve the desired image sensor cooling characteristics.

In another exemplary embodiment, an image sensor enclosure apparatus may be configured with a non-hermetic or non-absolute seal, which may be constructed of gasket/s, adhesive seal/s, or any other type or combination of types of sealing materials. One example of such a non-hermetic or non-absolute seal may be described as a seal that acts to substantially isolate the image sensor chamber from the atmosphere of the external environment under the intended external conditions (operating pressure and temperature) of the enclosure apparatus, but which allows communication with the atmosphere of the external environment upon a change in the external conditions. Such a non-hermetic seal may be implemented to create and maintain an image sensor vacuum chamber or dry gas-filled image sensor chamber under intended external operating conditions. Another example of a non-hermetic or non-absolute seal may be further characterized as an adjustable or pressure-equalizing seal that physically isolates the internal atmosphere of an image sensor chamber from the atmosphere external to the chamber, but which at the same time allows the gas pressure within the chamber to equalize to the gas pressure external to the chamber. Such a pressure-equalizing seal substantially prevents exchange of gas molecules between the external atmosphere and the image sensor chamber under conditions where the pressure of the external atmosphere remains static relative to the internal atmosphere of the image sensor chamber, but which allows exchange of molecules between the external environment and the image sensor chamber upon a change in the pressure of the external atmosphere relative to the pressure within the image sensor chamber.

The disclosed systems and methods may be employed in a wide range of imaging applications including, but not limited to, normal video resolution imaging applications (e.g., applications having data rates consistent with NTSC or PAL standards), as well as video imaging applications having higher resolution than NTSC or PAL standards (e.g., applications having pixel resolutions of 1280×720 and greater in combination with frame rates of greater than or equal to about 15 frames per second, alternatively applications having pixel resolutions of 1280×720 and greater in combination with frame rates of greater than or equal to about 30 frames per second, alternatively applications having pixel resolutions of 1280×720 and greater in combination with frame rates of from about 15 to about 30 frames per second, alternatively applications having pixel resolutions of 1280×1024 and greater in combination with frame rates of greater than or equal to about 15 frames per second, alternatively applications having pixel resolutions of 1280×1024 and greater in combination with frame rates of greater than or equal to about 30 frames per second, and further alternatively applications having pixel resolutions of 1280×1024 and greater in combination with frame rates of from about 15 to about 30 frames per second).

Examples of higher resolution video imaging applications with which the disclosed systems and methods may be implemented include, but are not limited to, any video imaging/viewing application where smooth perceptual motion is desired or where it is desired to capture images that have a high percentage of change during subsequent video frames. Advantageously, the disclosed systems and methods may be employed to greatly improve the performance of CMOS imaging devices (having faster readout rates relative to CCD imagers) in such higher resolution video imaging applications by using TEC to compensate for the relatively lower SNR of CMOS imagers (as a function of temperature) as compared to CCD imagers. In this regard, CCD imagers lack a readout of image data that is sufficiently fast to perform satisfactorily in such higher resolution video imaging applications. The disclosed systems and methods advantageously allow TEC to be implemented in an imaging environment in a manner that is effective with regard to cost, power, performance and manufacturing complexity.

In various embodiments of the disclosed systems and methods disclosed herein, a number of exemplary image sensor housing features may be advantageously implemented, alone or in combination, to achieve improved image sensor resolution/performance, increased ease of manufacture, and/or reduced cost of manufacture. Examples of such exemplary features include, but are not limited to: integrated sealed chamber housing and heatsink component; integrated sealed chamber lid enclosure component with integrated window; various techniques for thermally isolating an image sensor; use of a multi-stage (e.g., dual stage) thermal electric cooler in an imaging application; provision of a commercially manufacturable (e.g., dual or multi-part sealed housing), thermally cooled, sealed, imaging system using a CMOS image sensor; provision of a video camera (e.g., closed circuit video camera) equipped with image sensor cooling system, and methods for cooling image sensors of such video cameras.

In one respect, disclosed herein is a cooled image sensor enclosure apparatus, including: one or more chamber enclosure components defining an image sensor chamber and an image sensor chamber window; an image sensor disposed within the image sensor chamber; and an image sensor cooling mechanism configured to transfer heat to an environment external to the image sensor chamber.

In another respect, disclosed herein is a cooled image sensor enclosure apparatus, including first and second chamber enclosure components coupled together to define an image sensor chamber therebetween, with an image sensor window being defined in at least one of the first and second chamber enclosure components. An image sensor may be disposed within the image sensor chamber and operatively positioned so as to receive light transmitted though the image sensor window into the image sensor chamber from an environment external to the image sensor chamber. One or more heat sink features may be disposed on an external surface of at least one of the first and second chamber enclosure components, and a thermal electric cooling device may be thermally coupled between the image sensor and the external heat sink features, the thermal electric cooling device being configured to cool the image sensor by transferring heat from the image sensor to the external heat sink features.

In another respect, disclosed herein is a video camera assembly including a video camera optical block, the video camera optical block including a cooled image sensor enclosure apparatus and image processing circuitry. The cooled image sensor enclosure apparatus may include: one or more chamber enclosure components defining an image sensor chamber and an image sensor chamber window, an image sensor disposed within the image sensor chamber, a heat dissipating device configured to transfer heat to an environment external to the image sensor chamber, and an image sensor cooling mechanism thermally coupled between the image sensor and the heat dissipating device. The image processing circuitry may be electrically coupled to the image sensor, and the video camera optical block may be configured so that the image sensor receives an image transmitted by optical components of the optical block through the image sensor chamber window.

In another respect, disclosed herein is a method of cooling an image sensor that may be disposed within an image sensor chamber. The method may include transferring heat from the image sensor to an environment external to the image sensor chamber using an image sensor cooling mechanism configured to transfer heat to the environment external to the image sensor chamber. The image sensor chamber may be defined by one or more chamber enclosure components, at least one of the one or more chamber enclosure components having an image sensor window defined therein.

In another respect, disclosed herein is a method of assembling an image sensor enclosure apparatus, including: thermally coupling an image sensor and an image sensor cooling mechanism to a heat dissipating device of a second chamber enclosure component so that the image sensor cooling mechanism may be thermally coupled between the image sensor and the heat dissipating device; and coupling a first chamber enclosure component to the second chamber enclosure component to form an image sensor chamber containing the image sensor, the second chamber enclosure component having an image sensor chamber window defined therein.

### BRIEF DESCRIPTION OF THE DRAWINGS

FIG. 1 is a side cross section view of a vacuum sealed image sensor enclosure apparatus according to one embodiment of the disclosed systems and apparatus.

FIG. 2A is partially disassembled top view of an image sensor enclosure apparatus according to one embodiment of the disclosed systems and apparatus.

FIG. 2B is perspective view of an image sensor enclosure apparatus according to one embodiment of the disclosed systems and apparatus.

FIG. 3 is a side cross section view of a non-vacuum sealed image sensor enclosure apparatus according to one embodiment of the disclosed systems and apparatus.

### DESCRIPTION OF ILLUSTRATIVE EMBODIMENTS

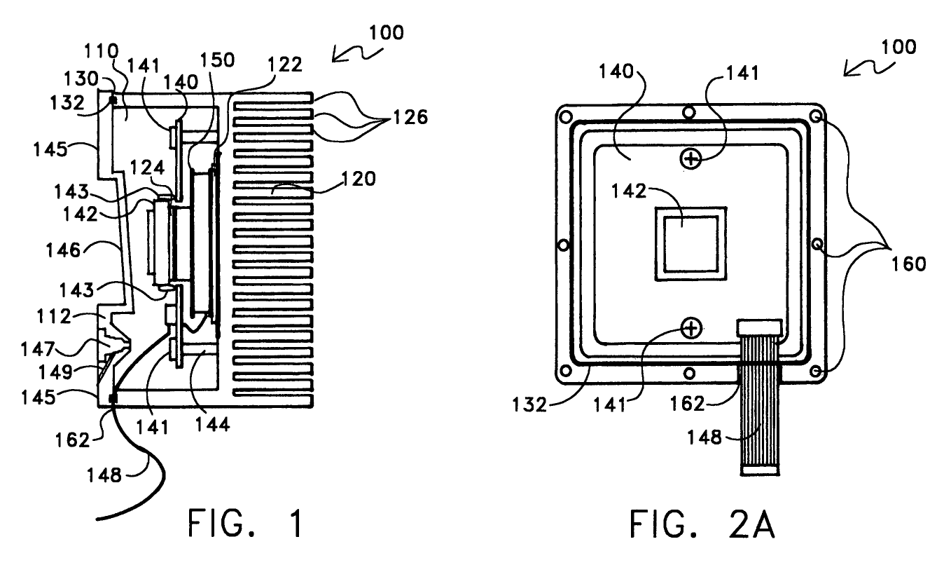

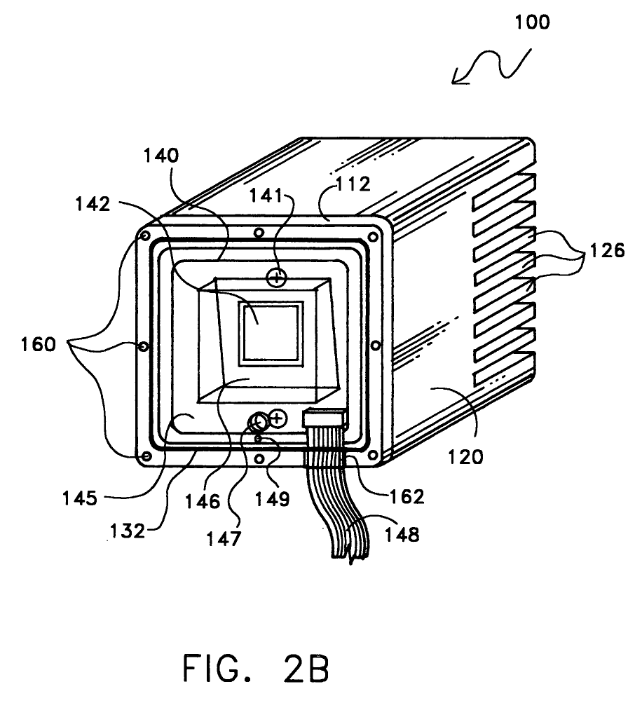

FIG. 1 shows an exemplary embodiment of a vacuum sealed image sensor enclosure apparatus 100 (e.g., implemented as an image sensor module for optical block assembly) having a single-walled image sensor vacuum chamber 110 formed by two components, an integrated window/chamber lid enclosure component 112 and a combined or integrated heatsink/chamber housing enclosure component 120. This combined functionality of heatsink and chamber enclosure advantageously provides for a single surface interface 130 formed between respective sealing surfaces of chamber lid enclosure component 112 and chamber housing enclosure component 120, and that may be sealed with a single piece gasket 132 as further shown and described in relation to FIGS. 2A and 2B. In the practice of the disclosed systems and methods, each of chamber lid enclosure component 112, gasket 132 and chamber housing enclosure component 120 may be dimensioned and composed of any one or more materials suitable for isolating image sensor chamber 110 from the intended environment external to image sensor chamber 110 (e.g., earth atmosphere, underwater or subsea environment, pressure vessel environment, high altitude environment, space environment, etc.) such that a desired vacuum and desired image sensor operating temperature may be maintained within chamber 110 when the assembled apparatus 100 is deployed under the pressure and temperature conditions of such an environment.

In the exemplary embodiment of FIG. 1, apparatus 100 may be configured for use in a ground level earth atmosphere environment (e.g., for surveillance camera or other closed circuit television use) using an integrated window/chamber lid enclosure component 112 constructed of a single piece of material (represented by cross hatch in FIG. 1) that is suitably transparent for transmitting light and images to image sensor 142 from the environment external to image sensor chamber 110, e.g., glass or plastic such as optical quality polycarbonate or optical grade acrylic. As shown, chamber lid enclosure component 112 may include an integrated slanted chamber window 146 that is formed from about 0.04″ thick transparent optical quality polycarbonate or optical quality acrylic surrounded by a peripheral area 145 that is formed from about 0.04 thick transparent polycarbonate or optical quality acrylic. It will be understood that these materials and thicknesses are exemplary only, and that a chamber lid enclosure component may be configured with other thicknesses of materials (e.g., thicker or thinner) as may be needed or desired to fit the requirements of a given application (e.g., sealed or unsealed chamber; vacuum, pressurized or non-pressurized chamber; type of material/s employed for chamber lid enclosure component; anticipated external conditions of temperature and pressure; etc.)

Chamber window 146 may be optionally recessed in a manner that disposes the center of the interior (i.e., chamber-side) surface of chamber window 142 closer to the surface of sensor 146 in order to minimize the gap between the interior surface of window 142 and the exposed surface of sensor 146, thus improving heat transfer from sensor 142 to the interior surface of window 146. In this regard, the center of the interior (i.e., chamber-side) surface of chamber window 146 may be spaced about 0.08″ from the exposed surface of image sensor 142. It will be understood that interior and exterior surfaces of chamber window 146 may be optionally slanted or angled (e.g., at an angle of from about 1° to about 20° C., alternatively at an angle of from about 10° to about 20°, or any other suitable angle) relative to the plane of image sensor 142 and/or the plane of peripheral area 145 of chamber lid enclosure component 112 in order to minimize reflections, as will be described further herein. However, non-slanted chamber window configurations may also be suitably employed.

Also illustrated in FIG. 1 is vacuum port 147 that may be present within chamber lid enclosure component 112 and dimensionally configured for accepting a vacuum tool or other mechanism through which vacuum may be applied to image sensor chamber 110. A sealant channel 149 may be present for introduction of sealant into vacuum port 147 in order to seal port 147 after vacuum has been applied. It will be understood that vacuum port 147 and sealant channel 149 represent only one exemplary mechanism for inducing and maintaining a vacuum within image sensor chamber 110, and that any other mechanism suitable for inducing and maintaining a vacuum within chamber 110 may employed, e.g., vacuum port with mechanical check valve, etc.

In the illustrated embodiment of FIG. 1, an image sensor cooling mechanism in the form of a dual stage TEC 150 has been provided within image sensor chamber 110 as shown, although a single stage TEC or multi-stage TEC having more than two stages may also be employed as image sensor cooling mechanisms in other embodiments. In this regard, any single or multi-stage TEC image sensor cooling mechanism may be employed that is suitable for providing sufficient heat transfer capacity (or cooling capacity) to maintain the temperature of a given image sensor (e.g., CCD, CMOS image sensor, etc.) within an acceptable operating temperature under the operating conditions of a given application, and given the operating temperature range, size and heat generating characteristics of the given image sensor. For example, a TEC may be selected based on thermal analysis of a image sensor cooling application using, for example, finite element modeling or any other suitable thermal analysis technique/s. Examples of suitable types of single or multi-stage TEC image sensor cooling mechanisms include, but are not limited to, OptoTec® Series single stage and multistage (cascade) cooling mechanisms available from Melcor Thermal Solutions of Trenton, N.J. In one exemplary embodiment of the apparatus of FIG. 1, a dual stage TEC cooling mechanism (e.g., OptoTec® Series dual stage (cascade) TEC from Melcor Thermal Solutions) may be employed to cool a ½ size CMOS image sensor.

Still referring to the exemplary embodiment of FIG. 1, integrated heatsink/chamber housing enclosure component 120 may be constructed of a single piece of thermally conductive material that is suitable for transferring heat from the image sensor cooling mechanism, in this case TEC 150, to the environment external to apparatus 100, e.g., thermally conductive metal such as aluminum, aluminum alloy, copper, copper alloy such as brass or bronze, etc. As shown, chamber housing enclosure component 120 may include integrated heat sink features 126, in this case a plurality of fins that are configured to provide a desired capability for transferring heat from apparatus 100 to the external environment. In this regard, heat sink characteristics (e.g., such as aspect ratio and pitch of heat sink fins, number of heat sink fins, etc.) may be designed to achieve desired heat transfer capability using any suitable technique, including conventional heat sink design practices known in the art. It will be understood that any other heat sink feature configuration may be employed that is suitable for providing a desired heat transfer capability from TEC 150 to the external environment under the operating conditions of a specific application, e.g., a plurality of heat sink fins having a different geometry than illustrated in FIG. 1, a roughened outer surface, a smooth outer surface where it provides sufficient heat transfer under the given operating conditions, etc.

It will also be understood that an image sensor enclosure apparatus may be implemented in other embodiments using any type and/or configuration of heat dissipating device (e.g., heat sink features, heat transferring conduit, etc.) that is suitable for transferring heat away from an image sensor cooling mechanism that cools an image sensor disposed within the apparatus. For example, a conduit of highly thermal conductive material (e.g., thermally conductive metal such as aluminum, aluminum alloy, copper, copper alloy such as brass or bronze) may extend through a plastic or relatively thermally insulative enclosure wall of an image sensor enclosure apparatus to transfer heat to remotely located heat sink features or to any other device suitable for accepting heat from the conduit. Alternatively, one or more entire walls of an image sensor enclosure apparatus (e.g., of integrated heatsink/chamber housing enclosure component 120) may be constructed of relatively high thermally conductive material (e.g., thermally conductive metal such as aluminum, aluminum alloy, copper, copper alloy such as brass or bronze) to enhance heat transfer away from an image sensor cooling mechanism.

As shown in FIG. 1, the base of TEC 150 is coupled to an internal or chamber-side surface of chamber housing enclosure component 120 with optional thermally conductive padding layer 122 disposed therebetween. When present, thermally conductive layer 122 may be composed of any material/s of suitable thickness suitable for enhancing thermal conductivity between TEC 150 and chamber housing enclosure component 120. Examples of suitable thermally conductive materials and material thicknesses include, but are not limited to, silicone-elastomer thermally conductive interface pads available from 3M™ of Maplewood, Minnesota, etc. An image sensor 142 is coupled to the top surface of TEC 150 with optional thermally conductive padding layer 124 disposed therebetween that may be composed of any material/s suitable for enhancing thermal conductivity between image sensor 142 and TEC 150, for example, any of the thermally conductive materials listed as suitable for use as thermally conductive padding layer 122. Image sensor 142 may be a CMOS image sensor, a CCD image sensor, or any other type of image sensor for which cooling is desired.

It will be understood that FIG. 1 illustrates just one possible exemplary configuration of an image sensor cooling mechanism as it may be operatively disposed or positioned relative to an image sensor and heat dissipating device (e.g., heatsink features) of an image sensor enclosure apparatus. In this regard, an image sensor cooling mechanism may be mounted or disposed in relation to other components of an image sensor enclosure apparatus in any other manner suitable for transferring sufficient heat from an image sensor to a heat dissipating device (e.g., such as a heat sink), and/or directly to an environment external to an image sensor chamber. For example, a TEC may be operatively disposed within or outside a chamber or enclosure wall of an image sensor enclosure apparatus. In such a case, a TEC may be configured to transfer heat away from an image sensor within the apparatus in any suitable manner, e.g., by direct physical coupling to the image sensor or by indirect physical coupling to the image sensor using thermally conductive material (e.g., using cold finger) where necessary or desirable.

Further, although TEC cooling mechanisms are illustrated herein, any other type of image sensor cooling mechanism/s suitable for cooling an image sensor within an image sensor enclosure apparatus may be employed (alone or in combination with TEC or other type/s of cooling mechanisms). Examples of other suitable types of image sensor cooling mechanisms that may be employed to transfer heat from an image sensor within an image sensor chamber to an environment external to the chamber (e.g., directly and/or via thermally-coupled heat dissipation device) include, but are not limited to, heat pipe cooling mechanisms (such as have been employed to cool processing chips within laptop computers) and fan cooling mechanisms (such as miniature fan cooling mechanisms that have been employed to cool circuitry within laptop computers). In this regard, one suitable type of heat pipe cooling mechanism takes advantage of latent heat of evaporation principles, e.g., using water vapor. One suitable type of fan cooling mechanism is a miniature fan cooling mechanism having a fan diameter of less than or equal to about 10 millimeters, although larger fan diameters may be employed where suitable for fitting the dimensions of a given image sensor enclosure apparatus application.

In one exemplary embodiment, a heat pipe cooling mechanism may be thermally coupled between an image sensor and a chamber enclosure component, e.g., to spread out heat from the image sensor across an integrated heatsink/chamber housing enclosure component to achieve more effective heat transfer to the heat sink features of the integrated heatsink/chamber housing enclosure component. In such an embodiment a heat pipe cooling mechanism may be directly coupled between the image sensor and the chamber-side wall of the chamber enclosure component, or it is possible that other thermally conductive material/s and/or mechanism/s (e.g., cold finger, thermally conductive pad, TEC cooling mechanism, combination thereof, etc.) may be coupled between the image sensor and the heat pipe cooling mechanism. Likewise, other thermally conductive material/s may be coupled between the heat pipe cooling mechanism and the chamber housing enclosure component (e.g., thermally conductive pads, heat spreader, combination thereof, etc.). It will also be understood that a heat pipe cooling mechanism may be implemented in other manner suitable for cooling an image sensor within an image sensor enclosure apparatus, for example, as the only cooling mechanism component (e.g., without a TEC cooling mechanism), and/or with a chamber housing enclosure component that does not have heat sink features.

In another exemplary embodiment, one or more fan cooling mechanism/s (e.g., miniature fan cooling mechanism/s with fan diameter of less than or equal to about 10 millimeters) may be employed to circulate air or other gas within an image sensor chamber (e.g., to help transfer heat from the image sensor to chamber-side surfaces of an integrated heatsink/chamber housing enclosure component by convection heat transfer) and/or to circulate air or other gas between an image sensor chamber and an environment external to the image sensor chamber (e.g., to help transfer heat from the image sensor to an environment external to the heat sink chamber by convection heat transfer through vent openings defined in one or more walls of the heat sink chamber). In the latter case, at least two vent openings may be provided in one or more chamber enclosure component/s to allow a fan cooling mechanism to circulate gas through the image sensor chamber by drawing relatively cooler external gas into the chamber from the external environment through a first vent opening and correspondingly expelling relatively warmer gas (e.g., heated by the image sensor) through a second vent opening to the external environment. If desired a filter mechanism (e.g., ion filter device, filter element, etc.) may be provided to filter external gas (e.g., air) before it enters the image sensor chamber. It will be understood that a fan cooling mechanism may be implemented in combination with one or more other cooling mechanism components (e.g., with a TEC cooling mechanism) or as the only cooling mechanism component (e.g., without a TEC cooling mechanism). Further, a fan cooling mechanism may be implemented with chamber housing enclosure components that have or do not have heat sink features.

As with TEC cooling mechanisms, other types of cooling mechanisms (e.g., heat pipe cooling mechanism, fan cooling mechanism, or any other suitable type cooling mechanism) may be configured for providing sufficient heat transfer capacity (or cooling capacity) to maintain the temperature of a given image sensor (e.g., CCD, CMOS image sensor, etc.) within an acceptable operating temperature under the operating conditions of a given application, and given the operating temperature range, size and heat generating characteristics of the given image sensor (e.g., selected based on thermal analysis of a image sensor cooling application using, for example, finite element modeling or any other suitable thermal analysis technique/s).

Still referring to FIG. 1, a printed circuit board (“PCB”) 140 is shown mounted to integrated heatsink/chamber housing enclosure component 120 by board mount fasteners 141 and board mount devices 144 that act to support PCB 140 in a manner such that it is positioned at a level adjacent image sensor 142 so as to facilitate electrical coupling between image sensor 142 and PCB 140 via electrical contact pins 143. As will be described further herein, board mounts 144 may be constructed of a thermally insulative material (e.g., such as nylon) to minimize transfer of heat from the integrated heatsink/chamber housing enclosure component 120 to PCB 140. In the illustrated embodiment, PCB 140 may include internal image processing circuitry, for example, circuitry that acts to process image sensor output signals (e.g., analog to digital conversion “ADC” circuitry, digital to analog “DAC” circuitry, digital signal processing “DSP” circuitry, etc.).

As shown, PCB 140 may be further configured with an internal opening of suitable dimensions such that PCB 140 may be fitted around the top of the second stage of TEC 150 at a position adjacent image sensor 142, but without contacting TEC 150, in the manner shown in FIG. 1. As will be described further herein, such a PCB configuration may be implemented to reduce undesirable transfer of heat through the PCB to TEC 150 and/or image sensor 142.

As shown in FIG. 1, image sensor 142 may be electrically coupled to internal image processing circuitry of PCB 140 by electrical contact pins 143, and internal circuitry of PCB 140 may be in turn coupled to external circuitry and devices (not shown) by suitable conductor/s such as flex print conductor 148. Such external circuitry and devices may include, for example, external video camera image processing circuitry such as external DSP circuitry for further signal processing, external ADC circuitry, external DAC circuitry, combinations thereof. Examples of image processing circuitry that may be suitably employed internally or externally in the practice of the disclosed systems and methods includes. but is not limited to, one or more circuit components as described and illustrated in concurrently filed U.S. patent application Ser. No. ______ entitled “SLIP RING APPARATUS”, by Washington et al. (attorney docket COVI:005); in concurrently filed U.S. patent application Ser. No. ______ entitled “ELECTROMAGNETIC CIRCUIT AND SERVO MECHANISM FOR ARTICULATED CAMERAS”, by Hovanky et al., (attorney docket COVI:003); and in U.S. patent application Ser. No. 60/456,294 filed on Mar. 20, 2003 and entitled “SYSTEMS AND METHODS FOR CREATION, TRANSMISSION, AND VIEWING OF MULTIRESOLUTION VIDEO”, by Washington, (attorney docket COVI:008PZ1), each of the foregoing patent applications being incorporated herein by reference.

It will be understood that the embodiment of FIG. 1 is exemplary only, and that image processing circuitry may be alternatively disposed internal to the image sensor chamber on a PCB or other suitable circuit device that is mounted elsewhere within the image sensor chamber, integrated within an enclosure wall forming the image sensor chamber, and/or mounted or otherwise located external to the image sensor chamber and enclosure apparatus. In any case, an image sensor may be electrically coupled to internal and/or external image processing circuitry via suitable contacts, conductor/s or combinations thereof as may be suitable for the given configuration.

FIG. 2A shows a top view of image sensor enclosure apparatus 100 of FIG. 1, with chamber lid enclosure component 112 removed. FIG. 2B shows a perspective view of image sensor enclosure apparatus 100 of FIG. 1, with chamber lid enclosure component 112 assembled to chamber housing component 120. As may be seen in FIGS. 2A and 2B, fastener holes 160 are provided on the sealing surface of enclosure 120 for accepting screws or other suitable fasteners that may be employed to removably secure chamber lid enclosure component 112 to chamber housing enclosure component 120. However, it will be understood that chamber lid enclosure component 112 may be removably or permanently secured to a chamber housing enclosure component 120 in any other suitable manner, for example, using fasteners received in holes provided on sealing surface of chamber lid enclosure component 112 or provided on sealing surfaces of both components 112 and 120, using adhesive material/s, using magnetic sealing surfaces, etc.

FIGS. 2A and 2B also show a peripheral sealing mechanism in the form of a single piece gasket 132 that may be positioned between the peripheral sealing surfaces of chamber lid enclosure component 112 and chamber housing enclosure component 120. Gasket 132 may be optionally received and contained in a recess or groove that is defined in one or both of the sealing surface/s of chamber lid enclosure component 112 and chamber housing enclosure component 120. Gasket 132 may be of any configuration and/or material suitable for providing the desired sealing capability between components 112 and 120 to fit a given application, e.g., standard rubber O-ring, silicon-based O-ring, urethane gasket, etc. It will also be understood that any other type or configuration of sealing mechanism/s may be employed to provide the desired sealing capability between components 112 and 120 to fit a given application including, but not limited to, multiple and concentrically disposed gaskets, flat gasket/s, liquid or spread-on gasket material/s, gasket or sealing material integral to sealing surface/s of components 112 and/or 120. etc. Furthermore, it is possible that no gasket or other sealing mechanism may be present where suitable sealing characteristics for a given application are obtained without a sealing mechanism, e.g., machined fit between sealing surfaces of components 112 and 120, etc.

Electrical conductors or other separate components that extend from image sensor chamber 110 to the external environment may be provided with a seal suitable for isolating image sensor chamber 110 from the external environment. For example, FIGS. 2A and 2B show electrical conductors in the form of flex print 148 passing through flex print seal 162 that may be provided between the sealing surfaces of components 112 and 120. In this regard conductor sealing components such as flex print seal 162 may be of any suitable material and configuration to provide the desired sealing characteristics for a given application, e.g., flouroelastomer, etc.

Although FIGS. 1, 2A and 2B illustrate an exemplary embodiment of a vacuum sealed image sensor enclosure apparatus having a single-walled sealed image sensor vacuum chamber, it will be understood that the disclosed systems and methods may be implemented in other embodiments using a non-vacuum image sensor chamber, e.g., chamber at atmospheric pressure, pressurized chamber, chamber containing one or more inert or other type of selected gas other than air (e.g., nitrogen, etc.), unsealed chamber, etc. In yet other embodiments, an image sensor enclosure apparatus may be configured with an image sensor chamber having multiple-wall enclosures, i.e., having two or more chamber walls that form a sealed cavity therebetween (e.g., having vacuum, dry air or other suitable gas present in a space or spaces created between the multiple walls) to minimize the heat transfer from the single stage TEC-sensor unit to the environment outside chamber 310.

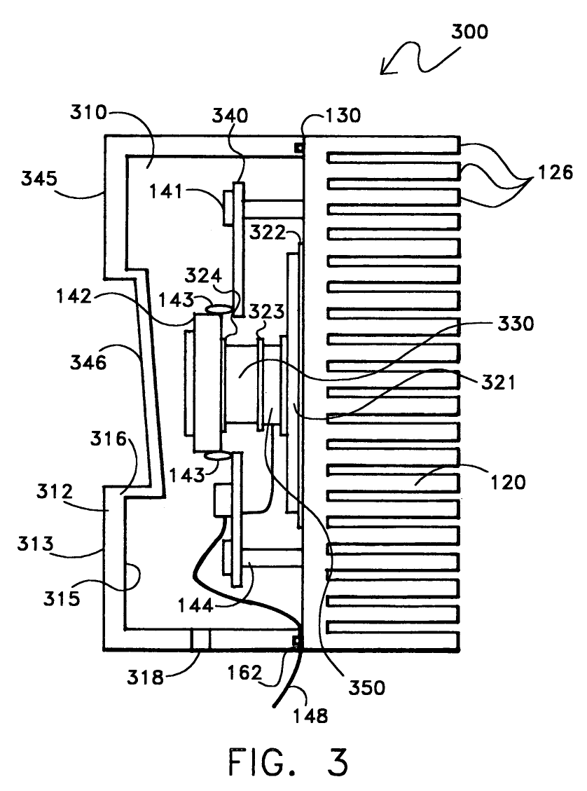

As an example, FIG. 3 shows an exemplary embodiment of a non-vacuum sealed image sensor enclosure apparatus 300 having a sealed image sensor gas chamber 310 (e.g., a sealed system having dry air or other suitable gas, such as nitrogen, in the inner chamber instead of a vacuum). In the illustrated embodiment, the sealed image sensor chamber is shown formed from an integrated window/chamber lid enclosure component 312 and a combined or integrated heatsink/chamber housing enclosure component 120 such as described and illustrated in relation to FIG. 1. As with the illustrated embodiment of FIG. 1, a single surface interface 130 may be provided between respective sealing surfaces of chamber lid enclosure component 312 and chamber housing enclosure component 120 that may be sealed with a single piece gasket 132. Although not shown, chamber 310 may also contain an optional desiccant or other mechanism suitable for drying sealed gas (i.e., in sealed chamber embodiments) to maintain suitably low moisture levels for extended periods of time.

As shown in FIG. 3, chamber lid enclosure component 312 is a double-walled enclosure having two adjacent walls, outer wall 313 and inner wall 315, which together form cavity 316. Each of outer wall 313 and inner wall 315 may be formed from a material that is suitably transparent for transmitting light and images to image sensor 142 from the environment external to chamber 310, e.g., optical quality polycarbonate, etc. The doublewalled enclosure of chamber lid enclosure component 312 may be constructed to be of any suitable thickness or varying thicknesses to provide sufficient transparency and to limit heat transfer to chamber 310 from the environment external to chamber 310. In one exemplary embodiment, each of outer wall 313 and inner wall 315 may be constructed of transparent polycarbonate having a thickness of about 0.06″ to form a sealed cavity therebetween having a width of about 0.04″, although other wall thicknesses and cavity widths are possible. As described in relation to the exemplary embodiment of FIG. 1, chamber lid enclosure component 312 of FIG. 3 may include an integrated image sensor chamber window 346 that may be optionally angled or slanted, and/or an exterior surface of chamber window 346 may be optionally recessed from the exterior surface of peripheral area 345. An optional sealable air escape passage 318 is shown provided in one wall of chamber lid enclosure component 312 for applying vacuum, gas, pressure, etc. as may be desired for a given configuration.

In the illustrated exemplary embodiment of FIG. 3, a single stage TEC 350 has been provided as shown, although a multi-stage TEC may also be employed if desired. As is the case with the illustrated embodiment of FIG. 1, the base of TEC 350 may be thermally coupled to an internal or chamber-side surface of chamber housing enclosure component 120. As shown in FIG. 3, an optional thermally conductive padding layer 322 and/or optional heat spreader component 321 may be coupled between TEC 350 and an internal surface of chamber housing enclosure component 120. As described in relation to the thermally conductive padding layers of FIG. 1, thermally conductive padding layers employed in the embodiment of FIG. 3 (e.g., 322, 323 and 324) may be composed of any material/s (e.g.,. thermally conductive metal such as aluminum) of suitable thickness suitable for enhancing thermal conductivity between adjacent coupled components. Heat spreader component 321 may be composed of any material/s of suitable thickness and surface area to increase the contact area through which heat may be transferred between TEC 350 and chamber housing enclosure component 120. Examples of suitable materials for heat spreader component 321 include thermally conductive metals such as aluminum, aluminum alloy, copper, copper alloy such as brass or bronze, etc.

As will be further described herein, one or more optional thermal extension component/s may be employed to increase cooling efficiency by distancing an image sensor from one or more inner chamber surfaces of an image sensor enclosure apparatus, and therefore decreasing heat transfer to the image sensor via thermal radiation from the inner surface/s of the chamber. For example, in FIG. 3 a thermal extension component in the form of cold finger 330 is shown coupled to the top surface of TEC 350 with optional thermally conductive padding layer 323 disposed therebetween. A thermal extension component, such as a cold finger, may be dimensioned as desired and composed of any thermally conductive materials (e.g., thermally conductive metal such as aluminum, aluminum alloy, copper, copper alloy such as brass or bronze, etc.) suitable for providing desired thermal conductivity and providing desired spacing between an image sensor and inner surface/s of an image sensor enclosure apparatus. In this regard, a thermal extension component such as cold finger may employed to dispose an image sensor closer to a window of a enclosure apparatus to improve radiative heat transfer from the image sensor to the interior or chamber-side surface of the window.

In the same manner as described and illustrated in relation to FIG. 1, FIG. 3 shows a printed circuit board (“PCB”) 340 mounted to integrated heatsink/chamber housing enclosure component 120 by board mount fasteners 141 and board mount devices 144 that act to support PCB 340 in a manner such that it is positioned at a level adjacent image sensor 142. Cold finger 330 is dimensioned to extend through the PCB 340 so as to come in contact with the image sensor 142, with optional thermal conductive padding layer 324 disposed therebetween. In a manner similar to that shown in FIG. 1, PCB 340 may be further configured with an internal opening of suitable dimensions such that PCB 340 may be fitted around cold finger 330, but without contacting cold finger 330. As will be described further herein, such a PCB configuration may be implemented to reduce undesirable heat transfer. Similar to the embodiment of FIG. 1, image sensor 142 may be electrically coupled to circuitry of PCB 340 by electrical contact pins 143, and circuitry of PCB 140 may be in turn coupled to external circuitry and devices (not shown) by suitable conductor/s such as flex print conductor 148 that may pass through flex print seal 162 that may be provided between the sealing surfaces of components 312 and 120.

It will be understood that the various aspects of the embodiments illustrated in FIGS. 1, 2A, 2B and 3 may be mixed and matched. In addition varying and different overall shapes may be used. For example, the assembly shown in FIG. 3 may be composed of a circular form for the polycarbonate chamber lid enclosure component 312 and a square extrusion for the integrated heatsink/chamber housing enclosure component 120.

Although FIGS. 1-3 illustrate image sensor enclosure apparatus having image sensor chambers formed between two exemplary chamber enclosure components (i.e., integrated window/chamber lid enclosure component and integrated heatsink/chamber housing enclosure component), it will be understood that an image sensor enclosure apparatus may be configured in any manner suitable for implementing and/or achieving one or more of the thermal isolation features disclosed and described herein. For example, an image sensor enclosure apparatus may be configured with an image sensor chamber that is formed from three or more sealably matable chamber enclosure components, or may be formed from two sealably matable chamber enclosure components that are dimensionally configured to sealably mate in alternate ways. Alternatively, an image sensor enclosure apparatus may be configured with an image sensor chamber that is formed from a single piece enclosure component that is manufactured (e.g., molded or otherwise manufactured) around an image sensor, image sensor cooling mechanism and other internal components of the image sensor enclosure apparatus.

Furthermore, chamber enclosure components of an image sensor enclosure apparatus may be multiple piece components. For example, in one exemplary embodiment, an integrated window/chamber lid enclosure component may be assembled from more than one piece, e.g., a separate transparent lens component assembled to a non-transparent or non-optical quality mounting flange component having a sealing surface that is configured for assembly to a sealing surface of an integrated heatsink/chamber housing enclosure component to form an image sensor chamber. Similarly, in another exemplary embodiment, an integrated heatsink/chamber housing enclosure component may also be assembled from more than one piece, e.g., having a separate heat sink feature component/s, such as heat sink fins, that are assembled to a separate enclosure component that in turn has a sealing surface configured for assembly to a sealing surface of a chamber lid enclosure component.

Furthermore, it will be understood that multiple image sensors and/or image sensor cooling mechanisms may be implemented within a single image sensor chamber of an image sensor enclosure apparatus, and/or a single image sensor enclosure apparatus may be configured with multiple chambers. In addition, alternate configurations of the disclosed components are possible, for example, provision of a single chamber enclosure component having both integrated window/s and integrated heat sink feature/s provided on or within common or different surfaces of the enclosure component. Furthermore, multiple windows or lens components may be provided within one or more inner surfaces of an image sensor housing (e.g., in conjunction with multiple image sensors so as to provide multiple views from a single image sensor housing).

The disclosed systems and methods may be implemented to provide image sensor enclosure apparatus (e.g., including those particular image sensor enclosure apparatus 100 and 300 specifically illustrated herein) for a variety of types of optical block assemblies. Examples of optical block assemblies with which the disclosed image sensor apparatus may be implemented as image sensor modules include, but are not limited to, conventional linear optical block assemblies as well as those folded optical block assemblies illustrated and described in concurrently filed U.S. patent application Ser. No. ______ entitled “OPTICAL BLOCK ASSEMBLY”, by Hovanky et al. (attorney docket COVI:006). Further information on configuration and use of image sensors in video camera lens units may be found, for example, in U.S. Pat. No. 4,404,595, which is incorporated herein by reference.

With reference to the disclosed systems and methods, particular performance and manufacturing features are described further below in relation to the embodiments of FIGS. 1, 2A, 2B and 3. In this regard, it will be understood that the embodiments of FIGS. 1, 2A, 2B and 3 are exemplary only and illustrate independent and separate features that may be implemented alone or in combination with other features. Some of these separate and independent features are discussed below in further detail and may be roughly categorized into two areas, performance and manufacturability features.

### Performance Features

1) Thermally Efficient Coupling of the TEC to the Sensor

The dual stage TEC 150 shown in FIG. 1 provides for an increased thermal gradient over that provided by a single stage TEC, such as single stage TEC 350 of FIG. 3. As illustrated in FIG. 1, dual stage TEC 150 extends through the PCB 140 to directly contact the bottom of image sensor 142 that may be, for example, a CMOS image sensor. To improve efficiency of heat transfer from image sensor 142 to integrated heatsink/chamber housing enclosure component 120, the interfaces between the integrated heatsink/chamber housing enclosure component 120, the image sensor 142, and the dual stage TEC 150 may include thermal padding layers 122 and 124 as previously described.

An optional thermal extension component may be configured in any suitable manner to extend the thermal path between an image sensor and an image sensor cooling mechanism, and/or between an image sensor cooling mechanism and a heat dissipating device, e.g., to create greater distance between the components or for any other reason. As shown in the exemplary embodiment of FIG. 3, a single TEC configuration may include an optional thermal extension component (e.g., cold finger 330) to extend through the PCB 340 and come in contact with the image sensor 142. As previously described, such a cold finger or other configuration of thermal extension component/s may be composed of copper or manufactured from other suitably heat conductive material/s. In the illustrated embodiment, use of such a cold finger provides greater efficiency by providing greater distance between the chilled sensor 142 and the integrated heatsink/chamber housing enclosure component 120, e.g., decreasing potential for radiative heat transfer from integrated heatsink/chamber housing enclosure component 120 to sensor 142. Besides the embodiment of FIG. 3, it will be understood that one or more optional thermal extension components may also be employed with multiple stage TEC configurations, and with different configurations that employ a single stage TEC.

An optional heat spreader component may be provided for increasing the contact area through which heat may be transferred between an image sensor cooling mechanism and a heat dissipating device, and may be of any areal dimension, thickness and material construction suitable for achieving desired heat spreading characteristics. As just one example, referring to the exemplary embodiment of FIG. 3, a copper plate may be used as a heat spreader component 321 over the top of an aluminum integrated heatsink/chamber housing enclosure component 120.

2) Reduction of Heat Transfer Between Cooled Sensor and External Environment

Cooling efficiency may also be determined by how much heat transfer occurs between the cooled sensor and the environment external to the image sensor chamber, i.e., transfer of heat from the external environment to the cooled sensor. In order to reduce this thermal transfer the number of conductive thermal paths may be reduced and the thermal resistance of each path may be maximized. For example, as shown in FIG. 1, the PCB 140 may be relieved (or cut-out) with an opening around the top of the upper second stage of the TEC 150 in order to eliminate one thermal path. Still referring to FIG. 1, and starting at the cooled image sensor 142, examples of alternate thermal paths through which heat may transfer from the external environment to the cooled sensor would be:

(a) From the image sensor 142 to the PCB 140 through the image sensors pins 143, through the board mounts 144, then through the integrated heatsink/chamber housing enclosure component 120 to the external environment.

(b) From the image sensor 142 to the PCB 140 through the image sensor's pins 143, then through the attached flex print 148 to the outside environment.

In order to increase the thermal resistance of path (a), the number of mounting points 144 may be kept to a minimum and may be composed of a thermally resistive material such as nylon. The PCB 140 itself may have copper-free areas around the mounting points 144 to also reduce heat transfer.

In order to reduce the heat transfer of path (b) due to the flex print cable 148, a minimum amount of copper may be used for the conductor of the flex print cable, and the flex print 148 may be made extremely thin by the use of polyimide material such as Kapton for the insulator. The arrangement shown also may be configured to minimize direct contact between enclosure 120 and the flex print by use of gaskets or sealants, e.g., with a gasket being on top of the flex print 148 and/or use of a sealant surrounding the other sides of the flex print 148. The use of a connector on the PCB/flex print interface also may be employed to add additional thermal resistance. Note that the use of a flex print 148 instead of direct wiring my also be employed to reduce the heat transfer since the amount of copper and the cross sectional wiring area is therefore minimized.

It will be understood that the foregoing described features for reducing heat transfer between cooled sensor and external environment are described in relation to FIG. 1 for illustration purposes only, and that any one or more of these features may be implemented alone or in combination in any other embodiment of the disclosed systems and methods.

3) Reduction or Elimination of Window Fogging/Condensation

As illustrated in FIGS. 1-3, embodiments-of the disclosed systems and methods may be advantageously and optionally configured so that at least a portion of the heat generated by an image sensor (e.g., CMOS image sensor) and/or cooling mechanism (e.g., TEC stack) may be transferred (e.g., channeled or “fedback”) so that it warms the window (e.g., window of a polycarbonate chamber lid enclosure component) of an image sensor enclosure apparatus to help prevent or reduce any fogging or condensation that may occur on the integrated window. For example, in the exemplary embodiments of FIGS. 1-3, this heat transfer may advantageously warm the chamber lid enclosure component 112 or 312 to help prevent or reduce any fogging or condensation on the respective integrated image sensor chamber window 146 or 346.

In each of the illustrated embodiments, the heat path from the image sensor and TEC stack to the respective image sensor chamber window is by radiant heat transfer, and additionally by convective heat transfer where a gas is present within the image sensor chamber. Note that if not warmed, it is possible that the surface of the respective chamber window 146 or 346 may be cooler than the atmosphere of the external environment due to convection cooling from the TEC and image sensor causing condensation to occur. This phenomenon is more likely to occur in non-vacuum sealed embodiments and in vacuum sealed embodiments where the vacuum inside the chamber is not perfect or has degraded over time. Although described in reference to FIGS. 1-3, it will be understood that other embodiments of the disclosed systems and methods may be configured so that condensation or fogging may be avoided in a similar manner.

4) Reduction or Elimination of Reflections

As illustrated in FIGS. 1 and 3, the integrated image sensor chamber window 146, 346 may be optionally angled or configured with a slight tilt or slant (e.g., in one embodiment angled in the range of between about 1 to about 20 degrees, alternatively between about 10 to about 20 degrees, relative to the plane of the peripheral area face 145, 345 of the chamber lid enclosure component 112, 312) that minimizes the probability that reflections will occur between the surface of the window and the optics in the imaging section preceding this assembly. Such an angle may be selected to fit the specific configuration of image sensor enclosure apparatus as implemented for a given application, and may be employed with image sensor housing configurations other than the specific illustrated exemplary embodiments of FIGS. 1-3.

### Manufacturing Features

In various embodiments of the disclosed systems and methods, the following features may be implemented alone or in combination to advantageously reduce manufacturing complexity and costs.

1) Reduction in Number of Separate Components

From a mechanical enclosure standpoint the number of components may be reduced in some embodiments, e.g., to two or three. For example, as previously described, the number of separate components of an image sensor enclosure apparatus may be minimized. For example, FIGS. 1-3 illustrate embodiments in which the mechanical enclosure of an image sensor enclosure apparatus may be assembled from two enclosures pieces (i.e., integrated window/chamber lid enclosure component and integrated heatsink/chamber housing enclosure component) with a single piece gasket disposed therebetween. In one embodiment, optical quality plastic (e.g., polycarbonate) may be employed to construct a single piece integrated window/chamber lid enclosure component.

2) Reduction in Airtight Mating Area Using Simplified Sealing Configuration

In sealed chamber embodiments, the airtight mating area between the sealing surfaces of chamber enclosure components (e.g., chamber lid enclosure component and chamber housing enclosure component) may be minimized and may to a large extent be sealed with a single gasket (e.g., with the exception of conductor seal such as flex print seal gasket 162 of FIGS. 1-3). In one embodiment, a conductor seal may be integrated as part of a single housing gasket to avoid the necessity of a separate gasket (e.g., such as flex print seal gasket 162) so that a single gasket may be employed to seal an image sensor chamber.

3) Reduction of Adhesive/Sealant Area

Use of one or more gaskets to form a conductor seal (e.g., use of a flouroelastomer gasket 162 to seal the top half of the flex circuit) minimizes the area required for a liquid adhesive or sealant. Advantageously, commercial grade seals (e.g., standard rubber O-rings, silicon rubber O-rings, urethane gasket material, etc.) may be employed to seal components of an image sensor enclosure apparatus. Such seals are commercially available and reduce the cost of manufacture compared to methods that employ substantial amounts of multiple types of adhesive sealants (e.g., epoxy, cement, etc.). In one exemplary embodiment, use of two-piece enclosure (e.g., chamber lid enclosure component and chamber housing enclosure component) with a single sealing surface therebetween reduces the area and/or complexity of the sealing surface as well as the need for adhesive sealants.

4) Reduced Requirement for Liquid Adhesive/Sealant

As described above, the area requiring an initially liquid form of adhesive or sealant is reduced. This is significant from both an ease of manufacturing standpoint and the reduction of the probability and/or amount of outgassing from the material that may fog the optical elements of the assembly.

5) Vacuum Creation within the Chamber

The vacuum port 147 shown in FIG. 1 has a relatively large opening at top that allows for a simple interface to a vacuum tool. The funnel shape allows for the sealant material to flow down to a point where the viscosity of the material stops any further flow. This sealant may be injected via the slanted sealant channel 149 shown or alternatively by a “tube-in-tube” mechanism that pulls vacuum from the outer tube and injects sealant from the inner tube.

6) Simple assembly

In one exemplary embodiment, assembly may involve the following five basic steps (in reference to FIGS. 1, 2A and 2B herein):

1) Assemble basic components of a TEC-CMOS image sensor unit (140, 142, 150) with flex print 148 onto the chamber housing enclosure component 120 using thermally conductive adhesive to secure the cooling mechanism/image sensor combination to the inner surface of the chamber housing enclosure component 120, and board mount devices 144 to secure PCB 140 to the inner surface of the chamber housing enclosure component 120.

2) Insert the single piece gasket 132 onto the enclosure (over the flex print).

3) Seal the flex print interface with a liquid adhesive.

4) Attach the chamber lid enclosure component 112 to the chamber housing enclosure component 120 with fasteners.

5) a) For a vacuum sealed image sensor chamber embodiment having vacuum port 147 and sealant channel 149, use a vacuum tool to apply vacuum to chamber 110 and then inject sealant into the sealant channel 149 to seal port 147.

b) For a vacuum sealed image sensor chamber embodiment having an air escape passage 318, use a single dual-purpose vacuum sealer tool that pulls a vacuum and applies sealant to the sealable air escape passage 318, or injects a dry air or dry nitrogen environment into the chamber then seals the sealable air escape passage 318.

c) For a non-vacuum sealed image sensor chamber embodiment, the enclosure apparatus may be simply assembled in a controlled environment e.g., an environment characterized by being temperature and dust controlled (e.g., clean booth, clean room, etc.).

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

### REFERENCES

The following references, to the extent that they provide exemplary system, apparatus, method, or other details supplementary to those set forth herein, are specifically incorporated herein by reference.

U.S. Provisional patent application Ser. No. 60/437,713 entitled “Systems And Methods For Location Of Objects”, by Richard G. Washington, (attorney docket COVI:002PZ1).

Concurrently filed U.S. patent application Ser. No. ______ entitled “Systems And Methods For Location Of Objects”, by Richard G. Washington, (attorney docket COVI:002).

U.S. Provisional patent application Ser. No. 60/437,711 entitled “Electromagnetic Circuit And Servo Mechanism For Articulated Cameras”, by Thao D. Hovanky, (attorney docket COVI:003PZ1).

Concurrently filed U.S. patent application Ser. No. ______ entitled “Electromagnetic Circuit And Servo Mechanism For Articulated Cameras”, by Thao D. Hovanky et al., (attorney docket COVI:003).

U.S. Provisional patent application Ser. No. 60/437,710 entitled “Systems And Methods For Actuating Lens Assemblies”, by Thao D. Hovanky, (attorney docket COVI:004PZ1).

Concurrently filed U.S. patent application Ser. No. ______ entitled “Systems And Methods For Actuating Lens Assemblies”, by Thao D. Hovanky, (attorney docket COVI:004).

U.S. Provisional patent application Ser. No. 60/437,712 entitled “Slip Ring Apparatus”, by Richard G. Washington and Thao D. Hovanky, (attorney docket COVI:005PZ1).

Concurrently filed U.S. patent application Ser. No. ______ entitled “Slip Ring Apparatus”, by Richard G. Washington and Thao D. Hovanky, (attorney docket COVI:005).

U.S. Provisional patent application Ser. No. 60/437,690 entitled “Optical Block Assembly”, by Thao D. Hovanky and Richard G. Washington, (attorney docket COVI:006PZ1).

Concurrently filed U.S. patent application Ser. No. ______ entitled “Optical Block Assembly”, by Thao D. Hovanky and Richard G. Washington, (attorney docket COVI:006).

U.S. Provisional patent application Ser. No. 60/456,294 entitled “Systems And Methods For Creation, Transmission, And Viewing Of Multi-Resolution Video”, by Richard G. Washington, (attorney docket COVI:008PZ1).

What is claimed is:

1. A cooled image sensor enclosure apparatus, comprising:
one or more chamber enclosure components defining an image sensor chamber and an image sensor chamber window;
an image sensor disposed within said image sensor chamber; and
an image sensor cooling mechanism configured to transfer heat to an environment external to said image sensor chamber.

2. The apparatus of claim 1, further comprising a heat dissipating device configured to transfer heat to an environment external to said image sensor chamber; and wherein said image sensor cooling mechanism is thermally coupled between said image sensor and said heat dissipating device to transfer heat to said environment external to said image sensor chamber by transferring said heat from said image sensor to said heat dissipating device.

3. The apparatus of claim 1, wherein said image sensor cooling mechanism comprises a fan cooling mechanism.

4. The apparatus of claim 2, wherein said image sensor cooling mechanism comprises a thermal electric cooler.

5. The apparatus of claim 4, wherein said image sensor cooling mechanism comprises a multiple-stage thermal electric cooler.

6. The apparatus of claim 2, wherein said image sensor cooling mechanism comprises a heat pipe cooling mechanism.

7. The apparatus of claim 4, wherein said image sensor cooling mechanism comprises a multiple-stage thermal electric cooler.

8. The apparatus of claim 2, wherein said image sensor comprises a CMOS image sensor.

9. The apparatus of claim 2, wherein said heat dissipating device comprises a heat sink.

10. The apparatus of claim 2, wherein said one or more chamber enclosure components comprise a first chamber enclosure component; and wherein said image sensor chamber window is integrated with said first chamber enclosure component.

11. The apparatus of claim 10, wherein said first chamber enclosure component comprises a single piece of transparent material.

12. The apparatus of claim 2, wherein said one or more chamber enclosure components comprise a second chamber enclosure component; and wherein said heat dissipating device is integrated with said second chamber enclosure component.

13. The apparatus of claim 2, wherein said image sensor is operatively disposed adjacent said image sensor window such that at least a portion of the heat generated by said image sensor during image sensor operation is transferred to said image sensor window to warm said image sensor window in a manner that reduces or prevents the occurrence of fogging and condensation on a surface of said image sensor window.

14. The apparatus of claim 2, wherein said one or more chamber enclosure components comprise first and second chamber enclosure components coupled together to define said image sensor chamber therebetween.

15. The apparatus of claim 14, wherein a sealing surface of said first chamber enclosure component is coupled to a sealing surface of said second chamber enclosure component with a single-piece seal disposed therebetween to define said image sensor chamber.

16. The apparatus of claim 2, wherein said image sensor chamber comprises a sealed image sensor chamber, said image sensor chamber being sealed to contain a vacuum or gaseous atmosphere therein.

17. The apparatus of claim 2, wherein said image sensor chamber comprises a non-hermetically sealed image sensor chamber.

18. The apparatus of claim 2, wherein said image sensor chamber is sealed with a pressure-equalizing seal.

19. The apparatus of claim 2, wherein said apparatus comprises a part of a video camera assembly.

20. A cooled image sensor enclosure apparatus, comprising:
first and second chamber enclosure components coupled together to define an image sensor chamber therebetween, an image sensor window being defined in at least one of said first and second chamber enclosure components;
an image sensor disposed within said image sensor chamber, said image sensor being operatively positioned within said image sensor chamber so as to receive light transmitted though said image sensor window into said image sensor chamber from an environment external to said image sensor chamber;
one or more heat sink features disposed on an external surface of at least one of said first and second chamber enclosure components;
a thermal electric cooling device thermally coupled between said image sensor and said external heat sink features, said thermal electric cooling device being configured to cool said image sensor by transferring heat from said image sensor to said external heat sink features.

21. The apparatus of claim 20, wherein said image sensor comprises a CMOS image sensor.

22. The apparatus of claim 21, wherein said thermal electric cooling device comprises a multiple-stage thermal electric cooler.

23. The apparatus of claim 21, wherein said thermal electric cooling device comprises a single-stage thermal electric cooler.

24. The apparatus of claim 20, wherein said image sensor window is integrated with said first chamber enclosure component; and wherein said heat sink features are integrated with said second chamber enclosure component.

25. The apparatus of claim 24, wherein said image sensor window is configured at an angle relative to the plane of said image sensor.

26. The apparatus of claim 24, wherein said first chamber enclosure component comprises a single piece of transparent material.

27. The apparatus of claim 20, wherein said image sensor is operatively disposed adjacent said image sensor window such that at least a portion of the heat generated by said image sensor during image sensor operation is transferred to said image sensor window to warm said image sensor window in a manner that reduces or prevents the occurrence of fogging and condensation on a surface of said image sensor window.

28. The apparatus of claim 24, wherein a sealing surface of said first chamber enclosure component is coupled to a sealing surface of said second chamber enclosure component with a single-piece seal disposed therebetween to define said image sensor chamber.

29. The apparatus of claim 20, wherein said image sensor chamber comprises a sealed image sensor chamber, said image sensor chamber being sealed to contain a vacuum or gaseous atmosphere therein.

30. The apparatus of claim 20, wherein said image sensor chamber comprises a non-hermetically sealed image sensor chamber.

31. The apparatus of claim 20, wherein said image sensor chamber is sealed with a pressure-equalizing seal.

32. The apparatus of claim 24, further comprising image processing circuitry disposed on a printed circuit board within said image sensor chamber; wherein said printed circuit board is located at a first distance from an inner surface of said second chamber enclosure component and is positioned between said image sensor and said inner surface of said second chamber enclosure component; wherein said thermal electric cooling device is thermally coupled between said image sensor and said inner surface of said second chamber enclosure component, said thermal electric cooling device extending through an opening defined in said printed circuit board without contacting said printed circuit board.

33. The apparatus of claim 24, further comprising:
image processing circuitry disposed on a printed circuit board within said image sensor chamber, wherein said printed circuit board is located at a first distance from an inner surface of said second chamber enclosure component and is positioned between said image sensor and said inner surface of said second chamber enclosure component;
a thermal extension component coupled between said image sensor and said inner surface of said second chamber enclosure component;
wherein said thermal electric cooling device is thermally coupled between said thermal extension component and said inner surface of said second chamber enclosure component, said thermal extension component extending through an opening defined in said printed circuit board without contacting said printed circuit board.

34. The apparatus of claim 24, wherein said first chamber enclosure component comprises two walls configured to form a sealed cavity therebetween.

35. The apparatus of claim 20, wherein said apparatus comprises a part of a video camera assembly.

36. A video camera assembly, comprising:
a video camera optical block, said video camera optical block comprising a cooled image sensor enclosure apparatus, said cooled image sensor enclosure apparatus comprising:
one or more chamber enclosure components defining an image sensor chamber and an image sensor chamber window,
an image sensor disposed within said image sensor chamber,
a heat dissipating device configured to transfer heat to an environment external to said image sensor chamber, and
an image sensor cooling mechanism thermally coupled between said image sensor and said heat dissipating device; and
image processing circuitry electrically coupled to said image sensor;
wherein said video camera optical block is configured so that said image sensor receives an image transmitted by optical components of said optical block through said image sensor chamber window.

37. The assembly of claim 36, wherein said image sensor cooling mechanism comprises a thermal electric cooler; wherein said image sensor comprises a CMOS image sensor; and wherein said heat dissipating device comprises a heat sink.

38. The assembly of claim 36, wherein said one or more chamber enclosure components comprise a first chamber enclosure component; wherein said image sensor chamber window is integrated with said first chamber enclosure component; and wherein said first chamber enclosure component comprises a single piece of transparent material.

39. The assembly of claim 36, wherein said one or more chamber enclosure components comprise a second chamber enclosure component; and wherein said heat dissipating device comprises one or more heat sink features that are integrated with said second chamber enclosure component.

40. The assembly of claim 36, wherein said image sensor is operatively disposed adjacent said image sensor window such that at least a portion of the heat generated by said image sensor during image sensor operation is transferred to said image sensor window to warm said image sensor window in a manner that reduces or prevents the occurrence of fogging and condensation on a surface of said image sensor window.

41. The assembly of claim 36, wherein said one or more chamber enclosure components comprise first and second chamber enclosure components coupled together to define said image sensor chamber therebetween; wherein said image sensor cooling mechanism comprises a thermal electric cooler, and said image sensor comprises a CMOS image sensor; wherein said image sensor chamber window is integrated with said first chamber enclosure component, and said first chamber enclosure component comprises a single piece of transparent material; and wherein said heat dissipating device comprises one or more heat sink features that are integrated with said second chamber enclosure component.

42. The assembly of claim 41, wherein said image sensor chamber comprises a sealed image sensor chamber, said image sensor chamber being sealed to contain a vacuum or gaseous atmosphere therein.

43. The assembly of claim 41, wherein said image sensor chamber comprises a non-hermetically sealed image sensor chamber.

44. The assembly of claim 41, wherein said image sensor chamber is sealed with a pressure-equalizing seal.

45. The assembly of claim 41, wherein said image processing circuitry comprises at least one of analog to digital conversion circuitry, digital to analog conversion circuitry, digital signal processing circuitry, or a combination thereof.

46. A method of cooling an image sensor that is disposed within an image sensor chamber, comprising:
transferring heat from said image sensor to an environment external to said image sensor chamber using an image sensor cooling mechanism configured to transfer heat to said environment external to said image sensor chamber; and
wherein said image sensor chamber is defined by one or more chamber enclosure components, at least one of said one or more chamber enclosure components having an image sensor window defined therein.

47. The method of claim 46, further comprising transferring said heat from said image sensor to said environment external to said image sensor chamber through a heat dissipating device thermally coupled to said image sensor; and wherein said image sensor cooling mechanism is thermally coupled between said image sensor and said heat dissipating device to transfer heat to said environment external to said image sensor chamber by transferring said heat from said image sensor to said heat dissipating device.

48. The method of claim 46, further comprising transferring said heat from said image sensor to said external environment using a fan cooling mechanism.

49. The method of claim 47, further comprising transferring said heat from said image sensor to said external environment using a thermal electric cooler.

50. The method of claim 47, further comprising transferring said heat from said image sensor to said external environment using a heat pipe cooling mechanism.

51. The method of claim 49, wherein said image sensor comprises a CMOS image sensor; and wherein said heat dissipating device comprises a heat sink.

52. The method of claim 47, wherein said one or more chamber enclosure components comprise a first chamber enclosure component; wherein said image sensor chamber window is integrated with said first chamber enclosure component; and wherein said first chamber enclosure component comprises a single piece of transparent material.

53. The method of claim 47, wherein said one or more chamber enclosure components comprise a second chamber enclosure component; and wherein said heat dissipating device comprises one or more heat sink features that are integrated with said second chamber enclosure component.

54. The method of claim 47, further comprising transferring at least a portion of the heat generated by said image sensor during image sensor operation to said image sensor window to warm said image sensor window in a manner that reduces or prevents the occurrence of fogging and condensation on a surface of said image sensor window.

55. The method of claim 47, wherein said one or more chamber enclosure components comprise first and second chamber enclosure components coupled together to define said image sensor chamber therebetween; wherein said image sensor chamber window is integrated with said first chamber enclosure component, and said first chamber enclosure component comprises a single piece of transparent material; and wherein said heat dissipating device comprises one or more heat sink features that are integrated with said second chamber enclosure component.

56. The method of claim 47, wherein said image sensor chamber comprises a sealed image sensor chamber, said image sensor chamber being sealed to contain a vacuum or gaseous atmosphere therein.

57. The assembly of claim 47, wherein said image sensor chamber comprises a non-hermetically sealed image sensor chamber.

58. The method of claim 47, wherein said image sensor chamber is sealed with a pressure-equalizing seal.

59. The method of claim 47, further comprising operating said image sensor as part of a video camera assembly.

60. A method of assembling an image sensor enclosure apparatus, comprising:
thermally coupling an image sensor and an image sensor cooling mechanism to a heat dissipating device of a second chamber enclosure component so that said image sensor cooling mechanism is thermally coupled between said image sensor and said heat dissipating device; and
coupling a first chamber enclosure component to said second chamber enclosure component to form an image sensor chamber containing said image sensor, said second chamber enclosure component having an image sensor chamber window defined therein.

61. The method of claim 60, further comprising coupling a peripheral single-piece seal between a peripheral sealing surface of said first chamber enclosure component and a peripheral sealing surface of said second chamber enclosure component to form_a sealed image sensor chamber.

62. The method of claim 61, further comprising electrically coupling said image sensor to one or more electrical conductors prior to coupling said first chamber enclosure component to said second chamber enclosure component; and positioning said one or more electrical conductors between said peripheral sealing surface of said first chamber enclosure component and said peripheral sealing surface of said second chamber enclosure component so that said one or more electrical conductors extend from an interior of said sealed image sensor chamber to an environment external to said sealed image sensor chamber.

63. The method of claim 62, further comprising applying sealant to an area of contact between said one or more electrical conductors and at least one of said peripheral sealing surface of said first chamber enclosure component and said peripheral sealing surface of said second chamber enclosure component prior to coupling said first chamber enclosure component to said second chamber enclosure component.

64. The method of claim 62, further comprising applying a vacuum to said sealed image sensor chamber through a vacuum port or air escape passage defined in at least one of said first or second chamber enclosure components; and then sealing said vacuum port or air escape passage to maintain said vacuum in said sealed image sensor chamber.

65. The method of claim 62, further comprising introducing a gas into said sealed image sensor chamber through a vacuum port or air escape passage defined in at least one of said first or second chamber enclosure components; and then sealing said vacuum port or air escape passage to maintain said introduced gas in said sealed image sensor chamber.

66. The method of claim 62, further comprising coupling said first chamber enclosure component to said second chamber enclosure in a controlled environment.

67. The method of claim 62, wherein said sealed image sensor chamber comprises a non-hermetically sealed image sensor chamber.

68. The method of claim 62, wherein said sealed image sensor chamber is sealed with a pressure-equalizing seal.

69. The method of claim 62, wherein said image sensor enclosure apparatus is configured to be part of a video camera assembly.
